(19) United States
(12) Patent Application Publication
(10) Pub. No.: US 2019/0188498 A1
(43) Pub. Date: Jun. 20, 2019

(54) Image Processing Method For Recognizing Ground Marking And System For Detecting Ground Marking

(71) Applicant: Institut Vedecom, Versailles (FR)

(72) Inventors: Marc REVILLOUD, Sceaux (FR); Mohamed Cherif RAHAL, Nanterre (FR); Dominique GRUYER, Beynes (FR)

(73) Assignee: Institut Français des Sciences et Technologies des Transports, de l'aménagement et des réseaux, Champs sur Marne (FR)

(21) Appl. No.: 16/301,061

(22) PCT Filed: May 11, 2017
(86) PCT No.: PCT/FR2017/051143

§ 371 Date: Nov. 13, 2018

(30) Foreign Application Priority Data
May 13, 2016 (FR) 1654322

(51) Int. Cl. G06K 9/00; G01S 7/481; G01S 17/89; G01S 17/93

(52) U.S. Cl. CPC G06K 9/00798; G01S 7/481; B60R 2300/804; G01S 17/936; G01S 17/89

(57) ABSTRACT

The present invention relates to an image processing method for recognizing ground marking, comprising a step of receiving at least one image of the ground at the front and/or at the rear of the vehicle, characterised in that it comprises a step of calculating a digital image corresponding to a confidence map consisting of assigning, to each pixel of the acquired image, a value corresponding to the degree of confidence that said pixel belongs to an area of marking, then performing a marking detection step by minimising the function f of the following equation: -F is the regression function-x±corresponding to the x coordinate of the ith pixel crossed by the agent-y±corresponding to the y coordinate of the ith pixel crossed by the agent-w±corresponding to the grey value V± of the ith pixel crossed by the agent-B designates a function space, and-λ designates the smoothing parameter which is a function of the type of road.

### CROSS-REFERENCE TO RELATED APPLICATIONS

This application is the National Stage under 35 USC § 372 of International App. No. PCT/FR2017/051143 filed May 11, 2017, which in turn claims priority to French application 1654322, filed on May 13, 2016, the contents of which (text, drawings and claims) are incorporated here by reference.

### FIELD OF THE INVENTION

The present invention relates to the field of the recognition of ground marking, in particular road marking or marking on vehicle parking lots.

### Background

A “marking” is intended to mean a line on the ground that is in a color different from the driving surface (a road or a traffic area or parking lot) and which defines a side of a travel lane. The line on the ground may be continuous or broken. A “marking” is also intended to mean the edge of the driving surface, i.e. the border between the surface intended for traffic, for example consisting of asphalt, and the shoulder.

A method for detecting road markings is generally used to assist the driver of a motor vehicle, for example by emitting a sound and/or light signal when the vehicle deviates from a travel lane. It is also intended to use this type of method for automatically controlling a motor vehicle, for example by automatically controlling the speed and/or the direction of the vehicle on the basis of the road markings detected.

The applications also relate to the provision of information to advanced driver assistance systems (ADAS) which assist the driver in keeping his vehicle in its travel lane on the basis of a real-time estimation of parameters of the lane edges, the design of a driverless vehicle, the analysis of road assets in order to evaluate the quality and the possible deterioration of existing markings, the design of advanced georeferenced databases, adaptive speed limiters, etc.

The technical difficulties in following and recognizing road marking lines result from onboard image acquisition conditions that are subject to shadows, glare, darkening by obstacles, etc.

The document leng, Tarel and Charbonnier, “Estimation robuste pour la détection et le suivi par camera,” [Robust estimation for camera detection and following] Traitement du signal [Signal processing] vol. 21 no. 3, pp. 205-226, 2004 describes a method for detecting a road marking in an image. In this method, the parameters of a curve that is representative road marking are estimated. This estimation is based on a set of points extracted from the image as being able to correspond to a portion of the road marking, and as a function of the noise modelled by the statistical correspondence between the extracted points and the road marking.

However, it has been found that the known methods for detecting road markings are of a limited degree of reliability. In particular, for example due to the state of the road, the lighting, the visibility, the presence of parasitic elements, the lack of road marking, or the presence of two road markings close to one another, the known methods for detecting road markings may provide imprecise or incorrect results. Moreover, the methods for detecting road markings are of no use in the case of an unmarked road.

In general terms, the methods for recognizing ground marking function in two steps:

Firstly, the primitives of road markings are extracted from camera data.

Secondly, the primitives are analyzed spatially using mathematical methods (polynomial regression, RANSAC, Hough transform) in order to extract therefrom the travel lanes. This model was used to develop the LIVIC multilane detection algorithm.

### State of the Art

From European patent EP 1221643 a device and a method for recognizing road marking lines is known from the prior art. This method comprises the following steps:

acquiring images of the road in front of the vehicle;

establishing a detection window of the travel lane on the basis of the image data;

detecting a travel lane mark which passes through the detection window on the basis of an item of brightness data at each point inside the travel lane detection window in question;

establishing a plurality of other travel lane detection windows;

detecting an edge intensity inside each noise detection window;

modifying a weight value of each of the travel lane detection windows in accordance with the edge intensity in each of the noise detection windows considered; and

calculating a road profile using any of the travel marks that are detected and the modified weight value.

The following article is also known in the prior art: AHARON BAR HILLEL ET AL: “Recent progress in road and lane detection: a survey,” MACHINE VISION AND APPLICATIONS, vol. 25, no. 3, Apr. 1, 2014 (2014-04-01), pages 727-745, XP055113665, ISSN: 0932-8092, DOI: 10.1007/s 00138-011-0404-2.

This document describes a solution for detecting road marking lines, primarily straight lines, implementing various alternatives of which one, described on page 738, proposes using polynomial functions of cubic splines.

The article BROGGI et al. “An agent based evolutionary approach to path detection for off-road vehicle guidance,” XP027922645, is also known, which article relates to an entirely different problem, i.e. that of guiding an all-terrain vehicle with respect to the edges of the driving surface.

### Drawbacks of the Prior Art

The solutions of the prior art are not entirely satisfactory. In particular, they are poorly suited to recognizing radius of curvature change topologies having a progressive angular acceleration which are encountered for example in the case of markings of exit lanes from a main lane. These connecting zones, that are continuous between a straight line and a circle and have a progressive angular acceleration, referred to as a clothoid, are difficult to recognize using the solutions of the prior art, because the processing is based on geometric models capable of recognizing straight lines or lines having a constant curvature. If the polynomial order is increased, the increased noise leads to recognition losses.

The solutions described in the AHARRON et al. document, which implement regression functions of the cubic spline type, are not satisfactory because they are very susceptible to the presence of wild points. The lack of robustness of processing methods of this kind is therefore incompatible with autonomous vehicle guidance applications.

### Solution According to the Invention

In order to overcome these drawbacks, the claimed invention relates to an image processing method for recognizing ground markings according to the main claim, and to the variants in the dependent claims.

### DESCRIPTION OF THE FIGURES

The present invention will be better understood upon reading the following detailed description of a non-limiting embodiment of the invention, with reference to the accompanying drawings, in which:

FIG. 1 is a schematic view of the hardware architecture of a ground marking recognition system;

FIG. 2 is a schematic view of the functional architecture thereof;

FIG. 3 is a logic diagram of an embodiment of a marking detection module;

FIG. 4 is a logic diagram of an embodiment of a simulation by means of a marking detection agent.

### DETAILED DESCRIPTION

### Hardware Architecture

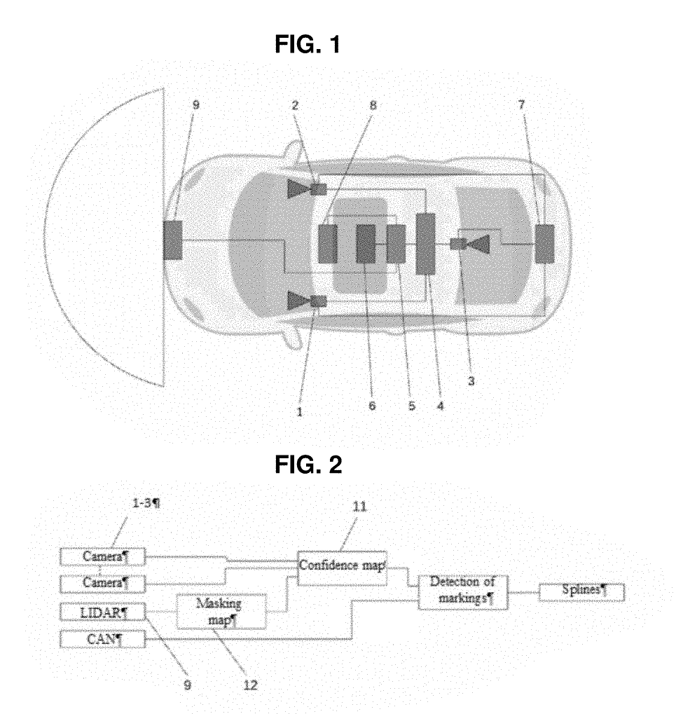

FIG. 1 is a schematic view of the hardware architecture of a ground marking recognition system according to an embodiment, installed in a motor vehicle.

In the embodiment described, the system comprises three cameras (1 to 3), two of which are arranged in front of the vehicle, on the right-hand side and on the left-hand side, and one of which is positioned centrally at the rear of the vehicle. The angle-of-view of each of the cameras (1 to 3) is flat, i.e. the field thereof is wider than it is high.

An Ethernet network switch (4) receives the signals from the cameras (1 to 3) and transmits said signals to a computer (5). This computer (5) ensures that the markings are processed and detected.

A second computer (6) receives data relating to the marking in the form of splines, and applies a scheduling algorithm in order to guide the vehicle.

The cameras (1 to 3) are supplied with power by means of a power source (7). Alternatively, the cameras (1 to 3) may be supplied directly by the network cable, using Power Ethernet technology.

The position and the orientation of each of the cameras (1 to 3) relative to the repository associated with the rear axle of the vehicle are known by a camera calibration process at the time the cameras are installed on the vehicle.

Intrinsic parameters corresponding directly to the camera and object model pair, and extrinsic parameters corresponding to the position and the orientation relative to the rear axle, are determined for each of the cameras (1 to 3).

The computer (5) also receives service signals provided by an angular position sensor of the steering column and by a sensor that detects the speed of rotation of the rear wheels. The CAN network transmits these data to the vehicle via an interfacing circuit (8).

This data make it possible to periodically recalculate the position of the markings detected at previous iterations, in order to map the markings onto the detection carried out during the current iteration.

A LIDAR (9), formed by a movable laser, ensures scanning in the direction in front of the vehicle in order to detect all elements on the plane of the road and to filter the image space in order to prevent processing of zones on the ground that are darkened by an obstacle or by a vehicle.

### Functional Architecture

The images acquired by the cameras (1 to 3) undergo image processing by means of a module (11) that also receives the data originating from a masking module (12) that processes the data transmitted by the LIDAR (9).

The module (11) calculates a confidence map in the form of a grayscale image, increasing the brightness of the zones that are capable of corresponding to masking, or reducing the pixel brightness for zones that are unlikely to correspond to a road marking.

In other words, the level of each pixel of the image represents the probability of the pixel belonging to a road marking.

### Marking Detector Operator

The confidence map is calculated by road marking detection operators.

The aim of the road marking detection operators is to create a confidence map that is subsequently used by marking tracker agents.

### Convolution Operator

The first operator is based on a convolution between the horizontal vicinity of a given pixel and a perfect marking model. The function f, characterized by all the pixels of a line, is convolved with the curve g, corresponding to a rectangular function. The operator is a function of l, the estimated width of the road marking which will correspond to the width of the rectangular function. The convolution is defined as follows:

$$l ( y ) = \frac{1}{2} {\sum }_{m = \frac{3}{2} s}^{\frac{3}{2} s} ( g ( m ) - f ( m ) ) , \{ \begin{matrix}α , g ( m ) = 0 , \\ \frac{1 - α}{2} , g ( m ) \neq 0 ,\end{matrix}$$

### Where;

Y corresponds to the abscissa of the processed pixel in a line of the image;
m corresponds to an integer variable;
l(y) corresponds to the grayscale that is representative of the confidence degree of the pixel;
alpha corresponds to the high/low ratio of g;
S corresponds to a predetermined parameter that corresponds to a nominal with of a road marking, projected in the image space and centered about y,
With g(m) being defined as follows:

$$g ( m ) = \{ \begin{matrix}0 , m < l or m > 2 l , \\ 255 , m \geq l and m \leq 2 l\end{matrix}$$

This processing, carried out by the module (11), therefore makes it possible to calculate the value of each pixel of an image corresponding to a confidence map that distinguishes the zones having a high probability of belonging to a road marking.

This processing, carried out by the module (11), is inhibited in the image zones corresponding to an item of masking data provided by the masking module (12).

### Detection of Masking

On the basis of the image, computed by the module (11), a detection module (13) performs processing by means of a multi-agent method, detecting the splines that correspond to the road markings.

### Determination of the Field of Perception of an Agent

The perception pattern of an agent is based on a triangular field of perception. The field of perception is defined by an apex (point corresponding to the position of the agent) and a base having a width 2.S (where S, defined above, corresponds to the nominal width of a marking projected in the image space), a depth L which is a function of the distance from the ego vehicle (distance of the zone processed by the agent from a reference point of the vehicle). The triangle defines a vector V_{agent} that corresponds to the direction of the agent, corresponding to the axis that is perpendicular to the base and passes through the apex.

The triangular field is then projected in the image space in order to define the set of pixels of the confidence image that will be processed by the agent.

### Determination of the Movement Pattern of an Agent

The movement pattern is determined by calculating the barycenter of the triangular field defined above, weighted by the value of the pixels of the field (low thresholding is optionally applied in order to eliminate pixels having too low a value.

The weighted barycenter determines a target point for which the agent aims. The angle between the vector V_{agent} and the vector V_{displacement}, defined by the apex of the triangle and the coordinates of the barycenter, is calculated.

If the set of points contained in the field of perception of the agent is lower than the threshold value, it is not possible to calculate the barycenter.

In this case, the target may be determined on the basis of data originating from one or more neighboring agents. This situation arises for example when the agent propagates between two dashes, and a neighboring agent propagates in a continuous marking. In this case, the development of the development direction of the first agent is identical to that of the second agent.

In the event that the agent cannot calculate a barycenter and does not have any neighboring agent that is able to calculate a barycenter, the angle of movement remains unchanged, the agent continuing to move in the direction specified previously.

The agent is moved in the direction that corresponds to the angle, restricted to a predetermined value. The predetermined value is a function of the type of road and of the maximum curvature intended for the detection process. The value may be variable, on the basis of a hypothesis regarding the type of lane on which the vehicle is travelling (lower value if the lane is a motorway, higher value if the lane is a state highway).

The movement length is constant and corresponds to the distance between two pixels.

### Behavior of the Agent

The agent alternates the perception steps and the movement steps, in an iterative manner, as far as the line that corresponds to the horizon in the image space.

At each point at which the agent passes, the value of the corresponding pixel and the position of the agent are recorded as a pair [Vₓ, Pₓ], with x varying between the departure point and the arrival point of the agent.

### Selection of the Agents

The next step comprises selecting the agents whose displacement corresponds to a marking.

For this purpose, a ratio R_{road} is recorded for each of the types of marking to be detected. For example, for a continuous marking the ratio is 1.

For a discontinuous marking, the ratio is between 0 and 1, depending on the modulation of the marking.
The agent is kept if:
   the ratio R_{agent i} between
      the values Vₓ of pixels above a predetermined threshold and
      the values Vₓ of pixels below a predetermined threshold

is lower than the ratio R_{road}, having a predefined margin of tolerance,
or
   the average intensity Vₓ of the pixels recorded by the agent is above a predetermined threshold.

### Creation of an Agent

The agents are created on the bottom edge, to the right or to the left of the image, and move towards the optical center of the image.

Three phases are distinguished:
the initialization phase, in which a plurality of N agents, each separated by a predetermined distance, are sent onto the confidence image
a re-initialization phase, in which the previous traces of the selected agents are used to re-initialize the corresponding agent, at the position thereof at the start of the trace thereof
creation, at each iteration, of
   an agent to the right of the righthand-most agent selected,
   or
   an agent to the left of the left hand-most agent selected.

The side selected is changed at each iteration.

### Estimation of the Shape of the Road Marking

The shape of the road marking, or of the cubic spline of the marking is estimated by means of processing comprising of calculating, on the basis of all the pixels that the agent crosses, a cubic spline that characterizes the marking.

The formula of the cubic spline is calculated by minimizing the function f of the following equation:

$${min}_{f ∈ B} {\sum }_{i = 1}^{n} {{W}_{i} ( {y}_{i} - f ( {x}_{i} ) )}^{2} + λ {\int }_{{x}_{1}}^{{x}_{n}} {( {f}^{″} ( x ) )}^{2} dx$$

where:

xᵢ corresponds to the x coordinate of the i^{th} pixel crossed by the agent

yᵢ corresponds to the y coordinate of the i^{th} pixel crossed by the agent

wᵢ corresponds to the gray value Vᵢ of the ith pixel crossed by the agent

B denotes a functional space,

λ denotes a smoothing parameter of between 0 and 0.15 that is a function of the type of road.

The parameter λ will be zero or close to zero on substantially straight roads, for example a motorway, and close to 0.1 for roads having frequent bends, for example mountain roads.

The parameter λ can be adjusted manually or on the basis of data originating from an external system, for example a geolocation device (GPS).

The result of this processing provides the smoothing spline corresponding to the road marking.

### Description of a Variant of an Embodiment

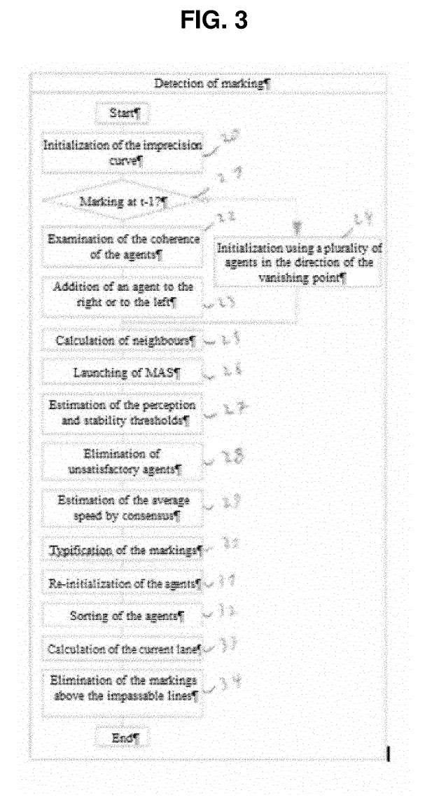

FIG. 3 is a further logic diagram of a solution for recognizing ground markings according to the invention, and more precisely of the marking detection module (13).

The processing is applied to the confidence images computed by the module (11).

The first step (20) comprises determining, for each marking dash, a set of parameters that describe the maximum development of the position thereof. The development takes into account the error resulting from the pitching motion of the vehicle and errors resulting from unevenness of the ground.

The next step (21) determines whether at least one selected agent, describing the marking on the preceding confidence image, was present during the previous iteration.

If at least one agent was present, the following step (22) comprises studying the spatial coherence of the marking estimations in order to eliminate the non-coherent agents.

In step (23), an agent is then added to the right or to the left of the agent that is furthest to the right or furthest to the left, respectively, of the agent selected during the previous iteration.

If there was no selected agent, a plurality of agents propagating towards the optical center is initialized (24).

Step (25) comprises, for each of the agents, estimating the neighboring agents before the agents propagate.

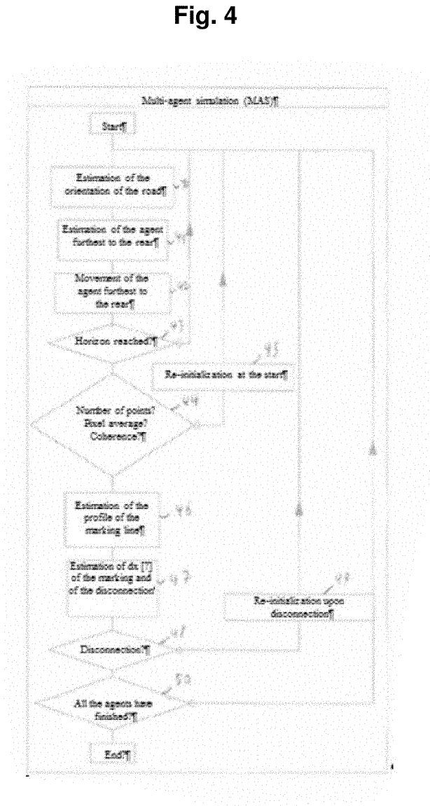

Step (26) comprises launching the process of the agent detecting the markings, described below with reference to FIG. 4.

Step (27) comprises estimating the perception and stability thresholds for each of the agents. The perception thresholds are calculated by estimating the dashes identified using the trace of the agent, and by extrapolating the position and the length of the following dashes.

The perception threshold of the agent is adjusted, for the following iteration, on the basis of said elements.

The stability is estimated on the basis of the ratio between the number of pixels of a value above a threshold value, and the number of pixels of a value below said threshold value.

Step (28) comprises eliminating the unsuitable agents if the stability value is below a threshold value, or if the average of the values of the pixels of the trace is below a threshold value.

Step (29) relates to estimating the average speed of the vehicle relative to the axis of the road. This estimation results from temporal resetting of the agent traces by means of a regression method.

Step (30) of typifying the markings comprises recording, in a buffer memory, the successive values of the first pixels of the trace of the agents, and in deducing therefrom the marking type by comparing them with a signature library of the different types of marking.

Step (31) comprises re-initializing the agents at the intersection point between the field of perception of the camera (frustum of the camera) and the cubic spline that characterizes the marking.

Step (32) relates to sorting the agents from left to right in order to calculate the neighbors for step (25) of the following iteration.

Step (33) comprises calculating the current lane on which the vehicle is located.

Step (34) comprises eliminating the markings above the impassable lines characterized during step (30). This step makes it possible to reduce the computing capacity required and to prevent an unexpected lane change in the event of an autopilot system being used.

### Logic Diagram of Multi-Agent Simulation

The first step (40) corresponds to the estimation of the orientation of the road; this is achieved by a consensus method relating to the direction of the agents.

Step (41) comprises determining the rearmost agent and in moving it (step (42)) using the movement pattern defined above.

Step (43) comprises checking whether the agent has reached the horizon line.
if it has not reached the horizon line, the process is repeated from step (40)
otherwise, if it has reached the horizon line, a check is carried out as to whether it complies with the stability thresholds, as described above, and whether the pixel average on the trace complies with the comparison described above.

A verification step (44) is then carried out. If the result is negative, the agent is re-initialized at the start, and a step (45) is implemented, comprises repeating the process from step (40) while eliminating the means for cooperating with the neighboring agents. The agent is then marked with a reinitialization flag. An agent that has already been reinitialized cannot be reinitialized a second time.

Subsequently (step 46) is implemented, comprises recording pixels of the agent trace, and then (step 47) is implemented, comprises estimating the movement of the marking between the current iteration and the previous iteration in order to allow for the processing of step (29) for estimating the average speed by consensus.

In step (48), an estimation is made by comparing the agent trace from the previous iteration and that of the current iteration, of possible disconnection of the agent. The disconnection is defined as a loss of data (marking dash) between the previous iteration and the current iteration.

In the event of disconnection being detected during the step (a step (49) is implemented, comprises repeating the process from step (40) while eliminating the means for cooperating with the neighboring agents. The agent is reinitialized at the start of the disconnection zone detected, and of the repetition of the process from step (40).

If all the agents have reached the horizon line, the process ends (step (50)).

1. An image processing method for recognizing ground marking, comprising a step of receiving at least one image of ground in front of and/or behind a vehicle, said method comprises a step of computing a digital image that corresponds to a confidence map, said step consisting in assigning each pixel of the image acquired a value that corresponds to the confidence degree of said pixel belonging to a marking zone, and then implementing a step of marking detection by minimizing the function fin the following equation:
$${min}_{f ∈ B} {\sum }_{i = 1}^{n} {{W}_{i} ( {y}_{i} - f ( {x}_{i} ) )}^{2} + λ {\int }_{{x}_{1}}^{{x}_{n}} {( {f}^{″} ( x ) )}^{2} dx$$
where:
F is the regression function,
xᵢ corresponds to the x coordinate of the i^{th} pixel crossed by the agent,
yᵢ corresponds to the y coordinate of the i^{th} pixel crossed by the agent,
wᵢ corresponds to the gray value Vᵢ of the i^{th} pixel crossed by the agent,
B denotes a functional space,
λ denotes the smoothing parameter that is a function of the type of road.

2. The image processing method for recognizing ground marking according to claim 1, wherein the method comprises the steps of adjusting the parameter λ on the basis of data originating from a geolocation system.

3. The image processing method for recognizing ground marking according to claim 1, wherein the method comprises a step of receiving at least one image of the ground in front of and/or behind a vehicle, characterized in that said method further comprises a step of partially masking the image acquired, using the data originating from a detection module for detecting elements located in the camera fields above the level of the ground.

4. The image processing method for recognizing ground marking according to claim 1, characterized in that it comprises the steps of:
receiving at least one image of the ground in front of and/or behind a vehicle,
pre-processing the image, consisting in assigning each pixel of said image a digital indicator that is representative of said pixel belonging to a marking,
initializing a multi-agent process consisting of:
propagating a plurality of agents, beginning at the edge pixels of the image [one pixel] and moving towards the optical center of said image, each of the agents being associated with a field of perception of N neighboring pixels,
commanding the movement of each of said agents in said field of perception, towards the barycenter of said field of perception that is weighted by said digital indicator of the pixels belonging to the field;
iterating said step for each of the agents, as far as the edges of the image strip containing at least one marking;
recording, for each of said agents, the coordinates of the pixels passed and the value of the associated digital indicator of belonging;
selecting the agent having the maximum recorded digital values,
recording the sequence of recordings of said agent,
and then, following said initialization step, for each new image,
re-estimating the starting position of each of the agents on the basis of the intersection between the making estimation obtained during the previous estimation and the edge of the image,
re-initializing the agents, selected during the previous step, at said starting position,
and then:
propagating all of said selected agents, beginning at said starting positions,
commanding the movement of each of said agents in the field of perception, towards the barycenter of said field of perception that is weighted by said digital indicator of the pixels belonging to the field,
iterating said step for each of the agents, as far as the edges of the image strip containing at least one marking,
recording, for each of said agents, the coordinates of the pixels passed and the value of the associated digital indicator of belonging,
selecting the agent having the maximum recorded digital values,
recording the sequence of recordings of said agent for the new image.

5. The image processing method for recognizing ground marking according to claim 3, wherein the method further comprises a processing step consisting, for each of said recordings, in applying smoothing by means of a cubic spline method weighted by the value of said digital indicator of belonging.

6. The image processing method for recognizing ground marking according to claim 3, wherein the method comprises means for exchanging data between marking detection means.

7. A system for detecting ground marking, comprising at least one camera and a computer, wherein said computer executes a program for commanding image processing for recognizing ground marking, comprising a step of receiving at least one image of the ground in front of and/or behind a vehicle, and wherein said method comprises a step of computing a digital image that corresponds to a confidence map, said step consisting in assigning each pixel of the image acquired a value that corresponds to the confidence degree of said pixel belonging to a marking zone, and then implementing a step of marking detection in order to compute a spline.

8. The system for detecting ground marking according to claim 7 wherein the system further comprises a LIDAR formed by a movable laser that ensures scanning in the direction in front of the vehicle in order to detect all elements on the plane of the road and to filter the image space in order to prevent processing of zones on the ground that are darkened by an obstacle or by a vehicle.
